(19) United States
(12) Patent Application Publication
(10) Pub. No.: US 2019/0308446 A1
(43) Pub. Date: Oct. 10, 2019

(54) BICYCLE COMPOSITE CLINCHER RIM AND WHEEL

(71) Applicant: SRAM, LLC, Chicago, IL (US)

(72) Inventors: DAVID MORSE, INDIANAPOLIS, IN (US); MICHAEL HALL, INDIANAPOLIS, IN (US); RUAN TROUW, MOORESVILLE, IN (US)

(73) Assignee: SRAM, LLC, Chicago, IL (US)

(21) Appl. No.: 15/947,480

(22) Filed: Apr. 6, 2018

(51) Int. Cl. B60B 5/02; B60B 21/02; B60B 21/04; B60B 21/06; B29C 70/86

(52) U.S. Cl. CPC B60B 5/02; B60B 21/025; B29L 2031/32; B60B 21/062; B29C 70/865; B60B 21/04

(57) ABSTRACT

A rim for a bicycle wheel includes a radially outer tire engaging portion having a first tire retaining portion and a second tire retaining portion spaced apart from the first tire retaining portion. The first tire retaining portion includes a first tire retaining section having a first outer wall and a first tire retaining wall opposite and spaced apart from the first outer wall. The second tire retaining portion includes a second tire retaining section having a second outer wall and a second tire retaining wall opposite and spaced apart from the second outer wall. The radially outer tire engaging portion is made of a composite material. The first outer wall and the first tire retaining wall, and the second outer wall and the second tire retaining wall, respectively, are separated by a material having a lower density than the composite material.

### FIELD OF THE DISCLOSURE

The present disclosure is generally directed to a bicycle rim, and more particularly, to a clincher tire attachment of a composite bicycle rim.

### DESCRIPTION OF RELATED ART

A traditional bicycle wheel may include a rim formed of extruded metals or other materials that are bent and bonded into a circular shape having consistently shaped cross sections. Recently, other materials, such as advanced carbon fiber reinforced composites, that can be manipulated into shape while soft and then set into a substantially rigid form, have been used in the manufacture of bicycle rims, which may be formed into circular shapes through non-extrusion based processes. Carbon fiber reinforced advanced composites may, for example, be used.

A method for manufacturing a carbon clincher bicycle wheel relies on the stacking of individual layers, or plies, of carbon fiber sheets to form structures such as a tire retaining portion of the rim. The carbon fiber sheets may be pre-impregnated with a resin or other matrix material, which undergoes a curing process to form a hardened rim. When the cured plies of carbon fiber sheets are loaded due to pressure from a tire on the wheel, particularly at a bead retention portion of the rim, a high short beam shear stress results within the stack of plies. In some circumstances, outward deflection of the vertical tire-retaining portion and resulting high interlaminar shear stresses in the rim cross-section causes the composite structure to delaminate along fiber-resin interfaces within the cured matrix.

In order to address the high short beam shear stress that results from loading due to pressure from the tire on the wheel, the number of plies within the stack may be increased. This, however, adds mass, weight, and cost for the carbon clincher bicycle wheel, and manufacturing of the carbon clincher bicycle wheel is more time consuming and complex. Also, positioning additional mass at the outer perimeter of the wheel rim to provide the increased number of plies may be disadvantageous. Added mass at the outer perimeter of the wheel rim, a location distal from the wheel hub, increases an amount of energy or power needed to accelerate or decelerate rotation of the wheel.

Also, in traditional composite clincher rims the interlaminar failure of the tire retaining portion may be further exaggerated within a bead retention portion of the tire retaining portion due to discontinuous fibers being used around and through the clincher hook portion. The discontinuous fibers provide an easier path for the delamination to migrate from a weaker part of the clincher hook portion, all the way through the laminate stack, resulting in compromise of the tire retaining portion (e.g., a tire retention vertical wall).

### SUMMARY

In one example, a rim for a bicycle wheel is provided. The rim includes a radially outer tire engaging portion having a first tire retaining portion and a second tire retaining portion spaced apart from the first tire retaining portion. The rim also includes a first sidewall, the first tire retaining portion extending from the first sidewall. The rim also includes a second sidewall spaced apart from the first sidewall, the second tire retaining portion extending from the second sidewall, the first sidewall and the second sidewall extending radially inward of the radially outer tire engaging portion. The first tire retaining portion includes a first tire retaining section, the first tire retaining section including a first set of layers of a first composite material forming a first outer wall and a second set of layers of a second composite material forming a first tire retaining wall opposite the first outer wall.

In one example, a rim for a bicycle wheel is made of a composite material and includes a radially outer tire engaging portion having a first tire retaining portion and a second tire retaining portion spaced apart from the first tire retaining portion. The rim also includes a first sidewall. The first tire retaining portion extends from the first sidewall. The rim includes a second sidewall spaced apart from the first sidewall. The second tire retaining portion extends from the second sidewall. The first sidewall and the second sidewall extend radially inward of the radially outer tire engaging portion. The first tire retaining portion includes a first tire retaining section. The first tire retaining section includes a first outer wall and a first tire retaining wall opposite and spaced apart from the first outer wall. The second tire retaining portion includes a second tire retaining section. The second tire retaining section includes a second outer wall and a second tire retaining wall opposite and spaced apart from the second outer wall. The first outer wall, the first tire retaining wall, the second tire retaining wall, and the second outer wall include layers of the composite material. The layers of the composite material are continuous from the first outer wall to the second outer wall, through the first tire retaining wall and the second tire retaining wall.

In one example, a wheel for a bicycle includes a central hub configured for rotational attachment to the bicycle, and a plurality of spokes attached to the central hub and extending radially outward from the hub. The plurality of spokes consist of a number of spokes. The wheel also includes a rim. The rim includes a radially outer tire engaging portion having a first tire retaining portion and a second tire retaining portion spaced apart from the first tire retaining portion. The rim also includes a first sidewall. The first tire retaining portion extends from the first sidewall. The rim includes a second sidewall spaced apart from the first sidewall. The second tire retaining portion extends from the second sidewall. The first sidewall and the second sidewall extend radially inward of the radially outer tire engaging portion. The rim also includes a radially inner portion disposed along an inner circumference of the rim. The plurality of spokes are attached to the radially inner portion of the rim. The radially outer tire engaging portion includes layers of the composite material. The layers of the composite material are continuous from the first tire retaining portion to the second tire retaining portion, such that the layers of the composite material are continuous around and through the radially outer tire engaging portion.

In one example, the composite material is a carbon fiber based material and/or fibers of the composite material are carbon fibers.

In one example, a bicycle rim includes a first outer wall and a first tire retaining wall, and/or a second outer wall and a second tire retaining wall, respectively, and the first outer wall and the first tire retaining wall, and/or the second outer wall and a second tire retaining wall are separated by only air. In another example, the first outer wall and the first tire retaining wall, and/or the second outer wall and a second tire retaining wall are separated by a foam.

### BRIEF DESCRIPTION OF THE DRAWINGS

Objects, features, and advantages of the present invention will become apparent upon reading the following description in conjunction with the drawing figures, in which:

FIG. 1 is a side view schematic of a bicycle that may be constructed to utilize a rim with a hollow clincher;

FIG. 2 is a side view of a wheel for a bicycle, such as the bicycle of FIG. 1;

FIG. 3 is a cross-section view taken along axis 3 of the wheel of FIG. 2;

FIG. 4 is a close-up cross-section view taken along axis 3 of the wheel of FIG. 2;

FIG. 5 is a close-up cross-section view taken along axis 3 of the wheel of FIG. 2 with a tire installed;

FIG. 6 is a close-up cross-section view of an example of a portion of a rim;

FIG. 7 is a close-up cross-section view of another example of a portion of a rim;

FIG. 8 is a close-up cross-section view of yet another example of a portion of a rim; and

FIG. 9 is a close-up cross-section view of an example of a portion of a rim illustrating layers of a composite material.

### DETAILED DESCRIPTION OF THE DISCLOSURE

The present disclosure provides examples of rims and wheels that solve or improve upon one or more of the above-noted and/or other disadvantages with prior known rims and wheels. The disclosed rims may include tire retaining portions with layers of composite material that are continuous from an outer wall to at least an opposite tire retaining wall. In other words, the layers of composite material are unbroken through one or both clincher hooks of the tire retaining portion. Exposed layer ends at the clincher hooks are thus eliminated or reduced, which eliminates or reduces crack initiation and propagation at ply interfaces through the tire retaining portion. The tire retaining portion may include two discrete walls (i.e. an outer wall and tire retaining wall) formed of layers of composite material (e.g., the continuous layers of composite material) spaced apart by a distance.

The space between the two discrete walls may be filled by a substance having a lower density than the composite material, such as air, a foam, or other materials. The tire retaining portion of the rim may be wider than known composite material tire retaining portions, providing additional structure for tire retention. A significant advantage of the disclosed rims is that the rim is stronger with less material usage compared to the prior art composite rims due to the layers of composite material being continuous through the tire retaining portion. Other advantages of the disclosed rims are that the rim weighs less, has a more advantageous distribution of mass, and is less expensive to manufacture compared to the prior art composite rims.

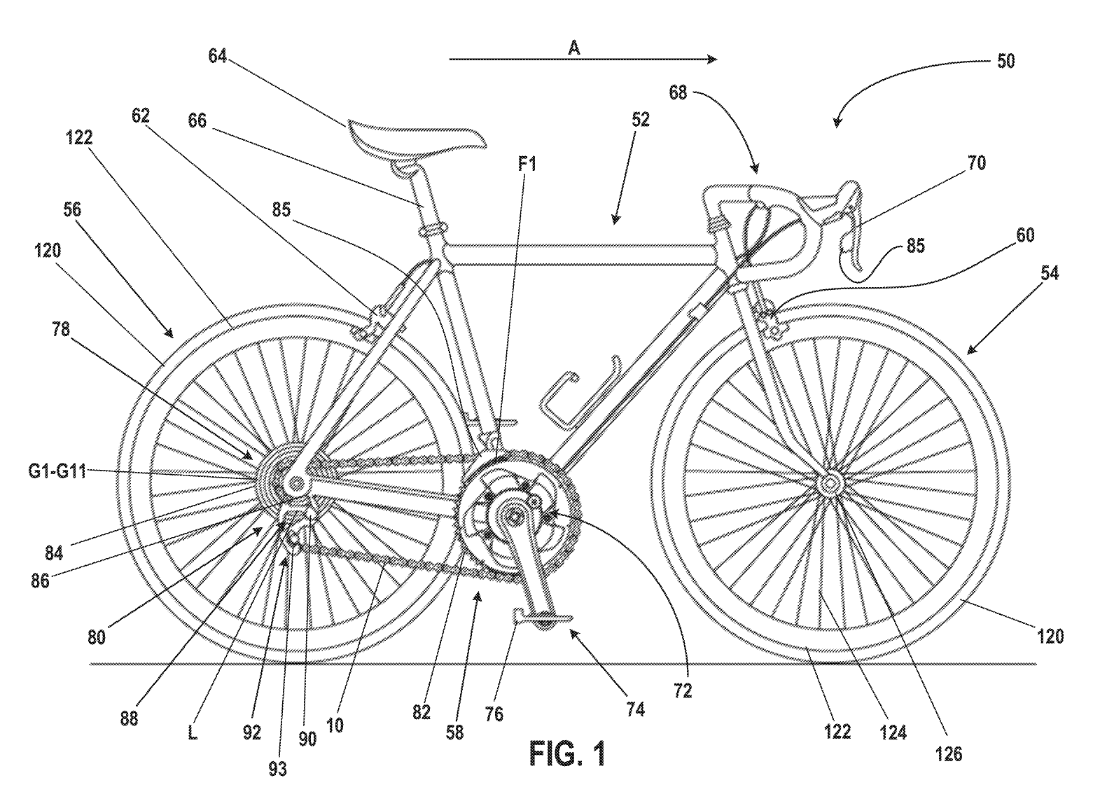

Turning now to the drawings, FIG. 1 generally illustrates a bicycle 50 that employs rims constructed in accordance with the teachings of the present disclosure. The bicycle 50 includes a frame 52, a front wheel 54 and a rear wheel 56 each rotatably attached to the frame 52, and a drivetrain 58. A front brake 60 is provided for braking the front wheel 54, and a rear brake 62 is provided for braking the rear wheel 56. The bicycle 50 also generally has a seat 64 near a rear end of the frame 52 and carried on an end of a seat tube 66 connected to the frame 52. The bicycle 50 also has handlebars 68 near a forward end of the frame 52. A brake lever 70 is carried on the handlebars 68 for actuating one of the front brake 60 or rear brake 62, or both. If the brake lever 70 actuates only one of the front brake 60 and the rear brake 62, a second brake lever (not shown) may also be provided to actuate the other brake. A front and/or forward riding direction or orientation of the bicycle 50 is indicated by the direction of the arrow A in FIG. 1. As such, a forward direction for the bicycle 50 is indicated by the direction of arrow A.

While the illustrated bicycle 50 depicted in FIG. 1 is a road bicycle having drop-style handlebars 68, the present disclosure may be applicable to bicycles of any type, including mountain bicycles with full or partial suspensions.

The drivetrain 58 has a chain 10 and a front sprocket assembly 72, which is coaxially mounted with a crank assembly 74 having pedals 76. The drivetrain 58 also includes a rear sprocket assembly 78 coaxially mounted with the rear wheel 56 and a rear gear change mechanism, such as a rear derailleur 80.

As is illustrated in FIG. 1, the front sprocket assembly 72 may include one or more coaxially mounted chain rings, gears, or sprockets. In this example, the front sprocket assembly 72 has one or more sprockets F1 each having teeth 82 around a respective circumference. As shown in FIG. 1, the rear sprocket assembly 78 may include a plurality (e.g., eleven) of coaxially mounted gears, cogs, or sprockets G1-G11. Each sprocket G1-G11 also has teeth arranged around a respective circumference. In an embodiment, a smaller diameter front sprocket may have a number of teeth that is smaller than the number of teeth on the larger diameter sprocket F1. The numbers of teeth on the rear sprockets G1-G11 may gradually decrease from the largest diameter rear sprocket G1 to the smallest diameter sprocket G11. Though not described in any detail herein, a front gear changer 85 may be operated to move from a first operating position to a second operating position to move the chain 10 between the front sprockets F1. Likewise, the rear derailleur 80 may be operable to move between eleven different operating positions to switch the chain 10 to a selected one of the rear sprockets G1-G11. In an embodiment, the rear sprocket assembly 78 may have more or fewer sprockets. For example, in an embodiment, a rear sprocket assembly may have twelve or thirteen sprockets. Dimensions and configuration of the rear derailleur 80 may be modified to accommodate a specific implemented plurality of sprockets. For example, an angle and length of the linkage and/or the configuration of the cage of the derailleur may be modified to accommodate specific sprocket combinations.

The rear derailleur 80 may be a wireless, electrically actuated rear derailleur mounted or mountable to the frame 52, or frame attachment, of the bicycle 50. The electric rear derailleur 80 has a base member 86 (e.g., a b-knuckle) that is mounted to the bicycle frame 52. A linkage 88 has two links L that are pivotally connected to the base member 86 at a base member linkage connection portion. A movable member 90 (e.g., a p-knuckle) is connected to the linkage 88 at a movable member linkage connection portion. A chain guide assembly 92 (e.g., a cage) is configured to engage and maintain tension in the chain. Other gear changing systems, such as mechanically or hydraulically controlled and/or actuated systems may also be used.

In operation, the chain 10 is routed around one of the rear sprockets (e.g. G1-G11). An upper segment of the chain 10 extends forward to the front sprocket assembly 72 and is routed around one of the front sprockets F1. A lower segment of the chain 10 returns from the front sprocket assembly 72 to the tensioner wheel and is then routed forward to the guide wheel. A guide wheel directs the chain 10 to the rear sprockets (e.g. G1-G11). Lateral movement of the cage plate 93, tensioner wheel, and guide wheel may determine the lateral position of the chain 10 for alignment with a selected one of the rear sprockets (e.g. G1-G11).

The bicycle 50 may include one or more bicycle control devices mounted to handlebars 68. The bicycle control devices may include one or more types of bicycle control and/or actuation systems. For example, the bicycle control devices may include brake actuation systems to control the front brake 60 and/or the rear brake 62, and/or gear shifting systems to control the drivetrain 58. Other control systems may also be included. For example, the system may be applied, in some embodiments, to a bicycle where only a front or only a rear gear changer is used. Also, the one or more bicycle control devices may also include suspension and/or other control systems for the bicycle 50.

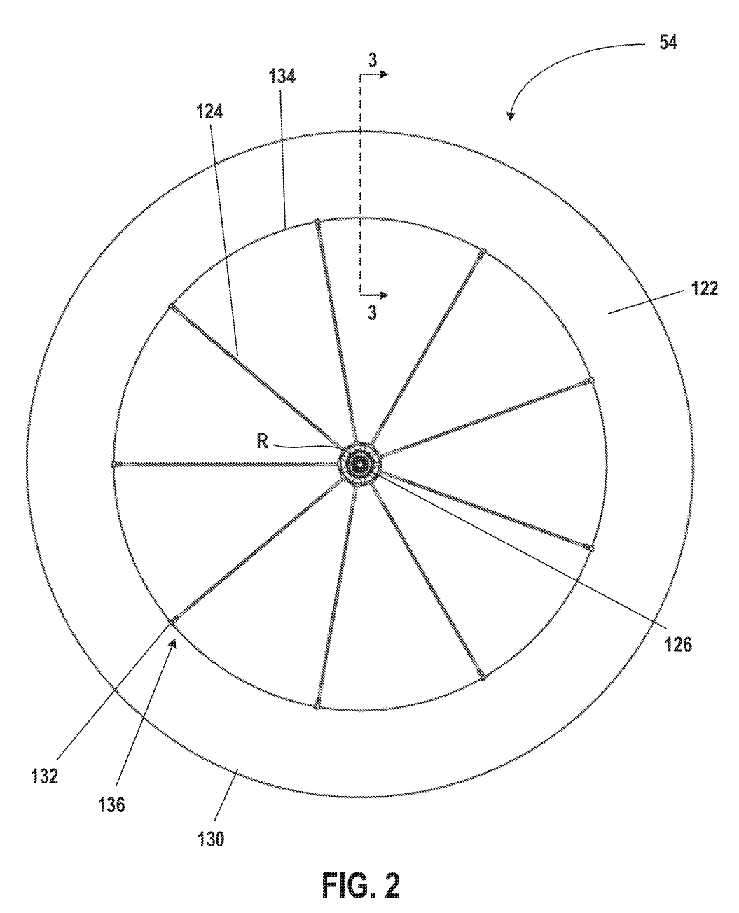

The front wheel 54 and/or the rear wheel 56 of the bicycle 50 may include a tire 120, attached to a radially outer tire engaging portion of a rim 122. As shown in FIGS. 1 and 2, a plurality of spokes 124 are attached directly to the rim 122. Alternatively, the spokes 124 may be attached and/or secured to the rim 122 with other structural components. The spokes 124 extend from the rim 122 and attach to a central hub 126. The spokes 124 are maintained with a tension between the rim 122 and the central hub 126 to provide the respective wheel 54, 56 with an operational rigidity for use on the bicycle 50. The central hub 126 is configured for rotational attachment to the bicycle frame 52.

FIG. 2 illustrates a bicycle wheel having a rim 122, spokes 124, and a central hub 126, such as the front wheel 54 of FIG. 1, removed from the rest of the bicycle 50 and without a tire attached. The rim 122 also includes a tire engaging portion 130 to engage with the tire 120, as is shown in FIG. 1. The tire engaging portion 130 is configured radially outward of a spoke receiving surface 132 that is disposed along an inner circumference 134 of the rim 122. In other words, the tire engaging portion 130 is a radially outer tire engaging portion. The tire engaging portion 130 is configured for attachment to tires using clincher tire attachment configurations for tires including beaded interlock attachments. Other configurations of the tire engaging portion 130 may also be provided to allow for the use of other types of tires on the rim 122. For example, tubeless tires including beaded interlock attachment types may be used.

The rim 122 provides structure for attachment of the spokes 124 to the rim 122 at a receiving portion of the rim 122, proximate to the spoke receiving surface 132. As such, the spoke receiving surface 132 is part of a spoke engaging portion 136 of the rim 122. In an embodiment, the spoke receiving surface 132 and the spoke engaging portion 136 may be separate parts and/or portions of the rim 122. For example, the spokes 124 may pass through the spoke receiving surface 132, and the structure for attachment to the rim 122 may be provided proximate to the tire engaging portion 130. In one example, the rim 122 is formed by carbon-fiber reinforced advanced composite. The rim 122 may, however, be formed of other materials and/or material combinations. In one example, carbon-fiber reinforced advanced composite forms a one-piece unitary rim of a singular collection of carbon-fiber layers including the tire engaging portion 130, two sidewalls, and the spoke engaging portion 136. Although as described herein spokes are referenced for attaching the rim 122 to the central hub 126, those skilled in the art will know that other attachment methods may be utilized such as advanced composite blades or full disc extending from the central hub 126 to rim 122. Other configurations may also be provided.

The front wheel 54 and the rear wheel 56 may include rims 122 configured for any size wheel. In an embodiment, the rims 122 are configured for use in wheels conforming to a 700 C (e.g. a 622 millimeter diameter clincher and/or International Standards Organization 622 mm) bicycle wheel standard.

The front wheel 54 and the rear wheel 56 may rotate about the central hub 126 in either direction. For example, as shown in FIG. 2, the front wheel 54 and the rear wheel 56 may be configured to rotate in a particular rotational direction about the central hub 126. In another example, the front wheel 54 and the rear wheel 56 may be configured to rotate in a direction opposite the particular rotational direction.

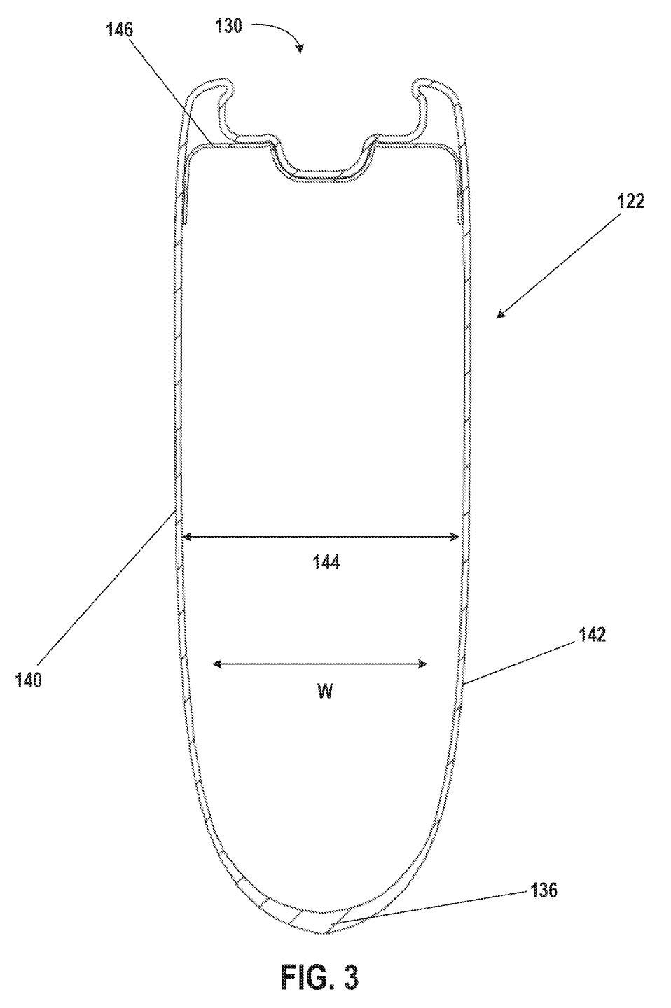

FIG. 3 is a cross-section of the rim 122 taken along axis 3 of FIG. 2. The rim 122 includes the tire engaging portion 130, the spoke engaging portion 136, and a first sidewall 140 and a second sidewall 142 extending between the tire engaging portion 130 and the spoke engaging portion 136. The first sidewall 140 is spaced apart from the second sidewall 142. In the example shown in FIG. 3, the first sidewall 140 is spaced apart from the second sidewall 142 an axial distance, creating an axial width 144 of the rim 122 in an axial direction W.

In one example, the tire engaging portion 130, the spoke engaging portion 136, the first sidewall 140, and the second sidewall 142 are formed of a single piece construction. The rim 122 may be formed of a single material having thin walls (e.g., layers of composite sheets). At least a portion of the rim 122 may have walls having a constant thickness. In one example, the tire engaging portion 130, the spoke engaging portion 136, the first sidewall 140, and/or the second sidewall 142 is a separate part and attached to the other parts of the rim 122. Specific areas and/or positions of the walls of the rim 122 may be thicker or thinner based on structural requirements of the rim 122.

The rim 122 also includes an optional support 146 (e.g., a base plate). At least a portion of the support 146 may be shaped and/or sized to conform to the tire engaging portion 130, the first sidewall 140, and/or the second sidewall 142. The support 146 may be made of any number of materials including, for example, a carbon-fiber reinforced composite, a metal such as aluminum, or other materials. The support 146 extends across the axial width 144 of the rim, such that the support abuts both the first sidewall 140 and the second sidewall 142. The support 146 may be physically connected to the tire engaging portion 130, the first sidewall 140, and/or the second sidewall 142 in any number of ways including, for example, with an adhesive, via press fit, or the support 146 is molded with the tire engaging portion 130. The support 146 may, for example, tie the first sidewall 140 and the second sidewall 142 together and/or may provide support for braking if the bicycle 50 includes rim brakes.

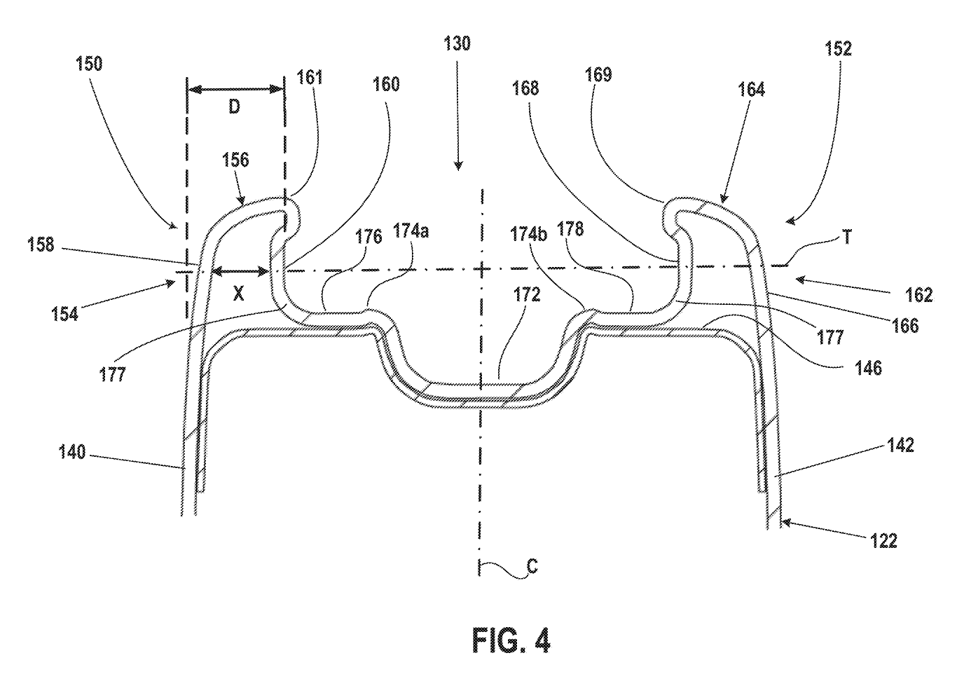

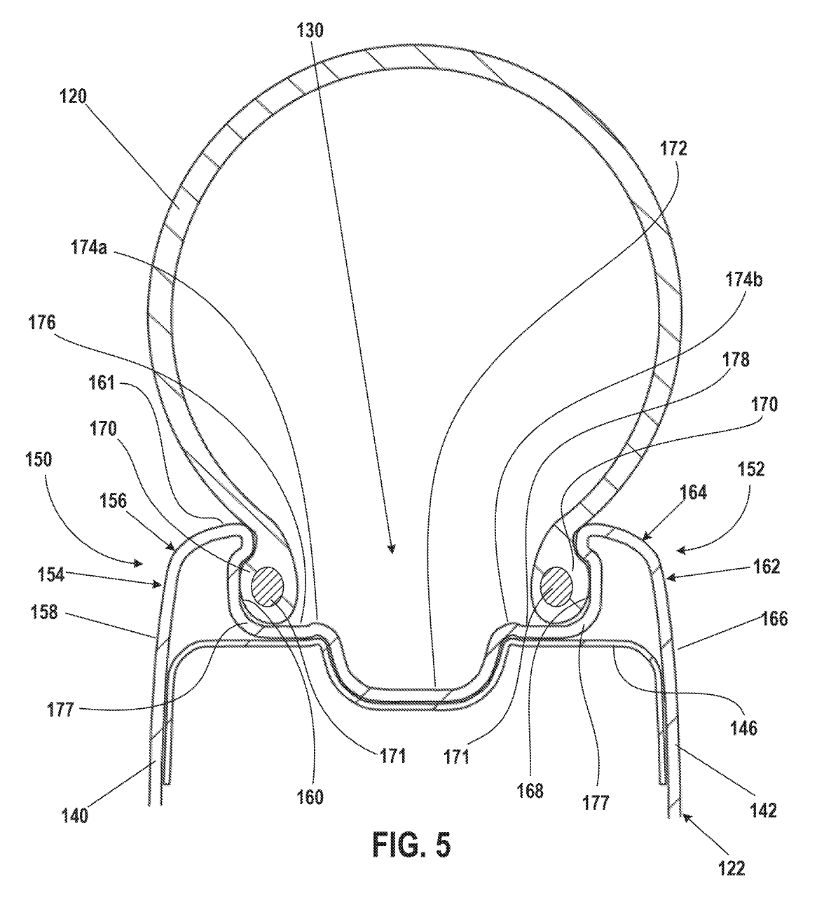

Referring to FIGS. 4 and 5, the radially outer tire engaging portion 130 includes a first tire retaining portion 150 and a second tire retaining portion 152 spaced apart from the first tire retaining portion 150. The first tire retaining portion 150 extends from the first sidewall 140, and the second tire retaining portion 152 extends from the second sidewall 142. The first sidewall 140 and the second sidewall 142 extend radially inward from the radially outer tire engaging portion 130.

The first tire retaining portion 150 includes a first tire retaining section 154 and a first protrusion 156 (e.g., a first bead retaining structure). The first tire retaining section 154 includes a first outer wall 158 and a first tire retaining wall 160 opposite and spaced apart from the first outer wall 158. The first protrusion 156 extends generally between the first outer wall 158 and the first tire retaining wall 160 and may extend inward toward the tire engaging portion 130. For example, the first protrusion 156 extends from the first outer wall 158 to the first tire retaining wall 160. In one example, the first protrusion 156 extends from the first tire retaining wall 160, towards the second tire retaining portion 152. At least a portion of the first protrusion 156 may extend inward toward the tire engaging portion 130 and form any number of shapes including, for example, a first hook 161.

The second tire retaining portion 152 includes a second tire retaining section 162 and a second protrusion 164 (e.g., a second bead retaining structure). The second tire retaining section 162 includes a second outer wall 166 and a second tire retaining wall 168 opposite and spaced apart from the second outer wall 168. The second protrusion 164 extends generally between the second outer wall 166 and the second tire retaining wall 168 and may extend inward toward the tire engaging portion 130. For example, the second protrusion 164 extends from the second outer wall 166 to the second tire retaining wall 168. In one example, the second protrusion 164 extends from the second tire retaining wall 168, towards the first tire retaining portion 150. At least a portion of the second protrusion 164 may extend inward toward the tire engaging portion 130 and form any number of shapes including, for example, a second hook 169.

As illustrated in FIG. 5, the tire 120 is, for example, a tubeless clincher tire. The tire 120 includes beads 170 that interact with the radially outer tire engaging portion 130 (e.g., the first tire retaining portion 150 and the second tire retaining portion 152) of the rim 122 to attach the tire 120 to and maintain the tire 120 on the rim 122. The beads 170 may include any number of materials 171 within the beads 170, such as, for example, a steel wire or aramid (e.g., Kevlar™) fiber, to prevent the tire 120 from moving off of the rim 122. Due to the reinforcement with the steel wire or the Kevlar™ fiber 171, for example, the beads 170 resist stretching from internal air pressure. Alternatively, the beads 170 may be made of a same material as the tire 120 (e.g., rubber).

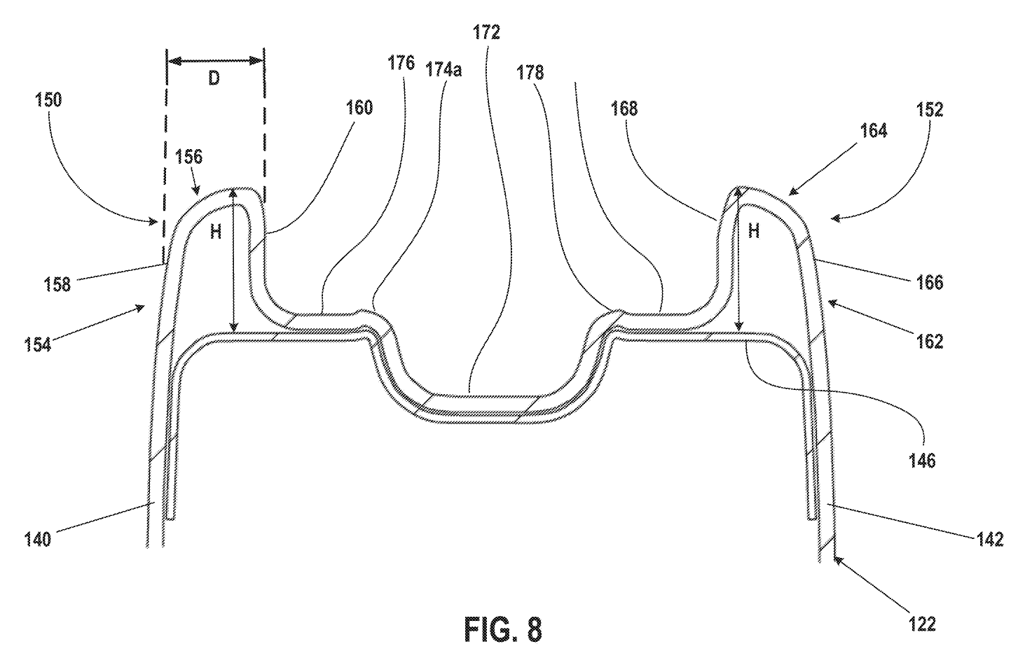

The radially outer tire engaging portion 130 also may include a well 172 positioned between the first tire retaining portion 150 and the second tire retaining portion 152 of the rim 122. The well 172 provides a volume into which the beads 170 of the tire 120 may be placed when the tire 120 is being attached to the rim 122. As the tire 120 is inflated, the beads 170 of the tire 120 move away from each other until the beads 170 interact with the first tire retaining portion 150 and the second tire retaining portion 152, respectively. As shown in FIG. 5, when the tire 120 is inflated, the beads 170 of the tire 120 abut the first tire retaining wall 160 and the second tire retaining wall 168, respectively. The first hook 161 and the second hook 169, for example, may assist in keeping the beads 170 of the tire 120 positioned within the radially outer tire engaging portion 130 (e.g., keep the beads 170 of the tire 120 engaged with the first tire retaining wall 160 and the second tire retaining wall 168) and thus keep the tire 120 from blowing off the rim 122. The contact between the beads 170 and the first tire retaining wall 160 and the second tire retaining wall 168, respectively, forms a seal between the inflated tire 120 and the rim 122. In some applications, hooks are not required (e.g., see FIG. 8).

In an embodiment, the radially outer tire engaging portion 130 also includes ridges 174 (e.g., bead bumps; a first bead bump 174a and a second bead bump 174b) on opposite sides of the well 172, respectively. A first shelf 176 (e.g., a first bead shelf) extends between the first tire retaining wall 160 and the first bead bump 174a, and a second shelf 178 (e.g., a second bead shelf) extends between the second tire retaining wall 168 and the second bead bump 174b. In one embodiment, curved transition regions 177 extend between the first shelf 176 and the first tire retaining wall 160, and the second shelf 178 and the second tire retaining wall 168, respectively. The bead bumps 174 are positioned on opposite sides of the well 172, respectively, and are raised relative to the first shelf 176 and the second shelf 178, respectively. The bead bumps 174 help retain the tire 120 on the rim 122 if the tire 120 loses pressure.

As illustrated in FIG. 4, the walls 158, 160, 168, and/or 166 of the tire engaging portion 130 may be spaced apart a distance X along a plane T that intersects with the walls 158, 160, 168, and/or 166. For example, each wall may have two distinct surfaces that intersect with the plane. The interior portion between the distinct surfaces may be exposed to a substance that is not part of the composite material, such as air and/or foam. In an embodiment, the plane T is orthogonal to a plane C defining an axial center of the rim with respect to a rim central rotation axis, such as axis R illustrated with respect to FIG. 2.

The rim 122 may be made of any number of materials including, for example, a carbon fiber reinforced polymer (CFRP) composite. Other materials may be used. Again referring to FIGS. 4 and 5, the first outer wall 158 and the first tire retaining wall 160 of the first tire retaining section 154, and the second outer wall 166 and the second tire retaining wall 168 of the second tire retaining section 162, respectively, are separated by a substance having a lower density than the CFRP composite, such as air or a material (e.g., a filler material), such as a foam or other low density material. In the example shown in FIGS. 4 and 5, the first outer wall 158 and the first tire retaining wall 160 of the first tire retaining section 154, and the second outer wall 166 and the second tire retaining wall 168 of the second tire retaining section 162, respectively, are separated by air (e.g., only air).

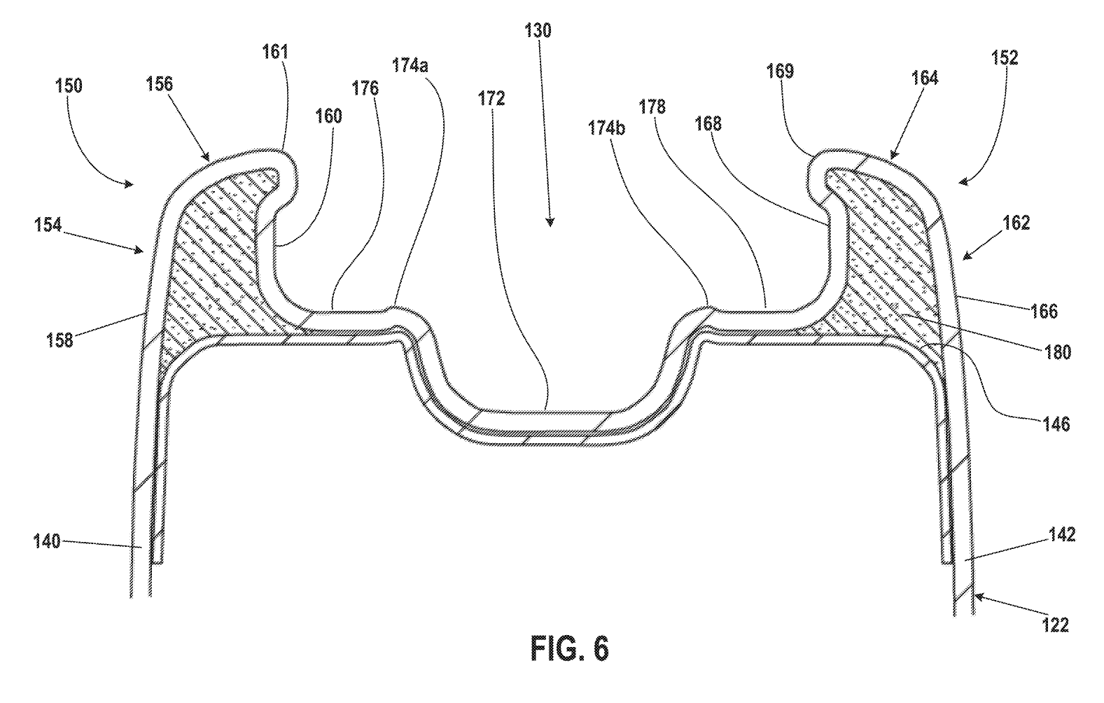

In the example shown in FIG. 6, the material that separates the first outer wall 158 and the first tire retaining wall 160 of the first tire retaining section 154, and the second outer wall 166 and the second tire retaining wall 168 of the second tire retaining section 162, respectively, is a foam 180 or another lightweight material. The foam 180, for example, fills a volume within the rim 122 between the radially outer tire engaging portion 130 and the support 146. In one example, the foam 180 fills less than all of the volume within the rim 122 between the radially outer tire engaging portion 130 and the support 146. In another example, the foam 180 fills more than the volume within the rim 122 between the radially outer tire engaging portion 130 and the support 146. In other words, other volumes within the rim 122 are filled with the foam. Different filler materials having a lower density than the other rim material may be used between the first outer wall 158 and the first tire retaining wall 160 of the first tire retaining section 154, and the second outer wall 166 and the second tire retaining wall 168 of the second tire retaining section 162, respectively. In one example, multiple filler materials are used between the first outer wall 158 and the first tire retaining wall 160 of the first tire retaining section 154, and/or the second outer wall 166 and the second tire retaining wall 168 of the second tire retaining section 162, respectively. The filler material may provide additional support for the radially outer tire engaging portion 130 without too large of a weight increase.

Referring to FIGS. 4-7, the first outer wall 158 and the first tire retaining wall 160 of the first tire retaining section 154, and the second outer wall 166 and the second tire retaining wall 168 of the second tire retaining section 162, respectively, are separated by any number of distances. For example, maximum distances D between the first outer wall 158 and the first tire retaining wall 160 of the first tire retaining section 154, and the second outer wall 166 and the second tire retaining wall 168 of the second tire retaining section 162, respectively, are four to ten millimeters. In other examples, the first outer wall 158 and the first tire retaining wall 160 of the first tire retaining section 154, and the second outer wall 166 and the second tire retaining wall 168 of the second tire retaining section 162, respectively, are separated by greater or lesser distances.

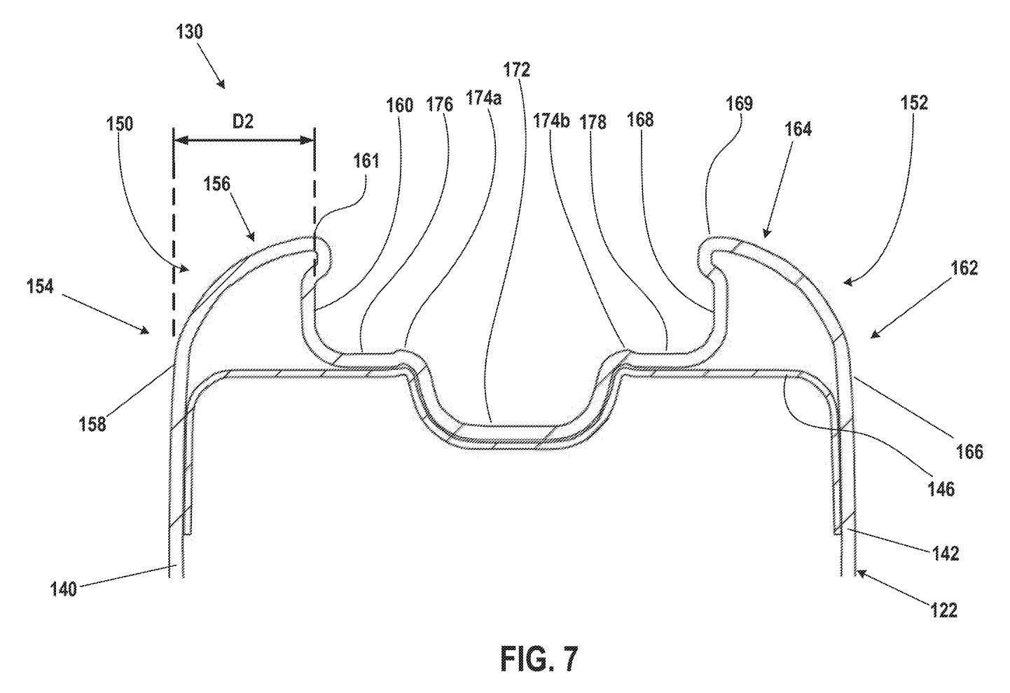

In the example shown in FIG. 7, maximum distances D2 between the first outer wall 158 and the first tire retaining wall 160 of the first tire retaining section 154, and the second outer wall 166 and the second tire retaining wall 168 of the second tire retaining section 162, respectively, are greater than the corresponding maximum distances shown in FIGS. 4-6. The greater maximum distances may result in a larger rim 122 but may also provide an increase in beam stiffness compared to the examples shown in FIGS. 4-6.

The maximum distances D, D2 between the first outer wall 158 and the first tire retaining wall 160 of the first tire retaining section 154, and the second outer wall 166 and the second tire retaining wall 168 of the second tire retaining section 162, may be the same in both the first tire retaining section and the second tire retaining section. In an embodiment, the maximum distances between the first outer wall 158 and the first tire retaining wall 160 of the first tire retaining section 154 may be different than the maximum distances between the second outer wall 166 and the second tire retaining wall 168 of the second tire retaining section 162.

The tires 120 for particular bicycles may require less air pressure compared to road bicycle. For example, the tires 120 for road bicycles may require a tire pressure of 80 to 130 psi or more, while the tires 120 for mountain bicycles may require a tire pressure of only 25 to 35 psi. Referring to the example shown in FIG. 8, for tires 120 pressurized at, for example, 75 psi or less, the first protrusion 156 does not extend from the first tire retaining wall 160, towards the second tire retaining portion 152, and the second protrusion 164 does not extend from the second tire retaining wall 168, towards the first tire retaining portion 150. In other words, portion of the first protrusion 156 and the second protrusion 164 do not form hooks, respectively. Instead, the first protrusion 156 extends from the first tire retaining wall 160, towards the first outer wall 158, and the second protrusion 164 extends from the second tire retaining wall 168, towards the second outer wall 166.

In the example shown in FIG. 8, the first tire retaining wall 160 and the second tire retaining wall 168 are taller in a direction H compared to the examples shown in FIGS. 4-7. Due to the lower tire pressure, protrusions 156, 164 including portions shaped like hooks may not be used for tire retention, but the taller first retaining wall 160 and second retaining wall 168 may provide the same function.

Referring to the examples shown in FIGS. 1-8, at least a portion of the rim 122 may be made of an advanced composite material. For example, the tire engaging portion 130, the spoke engaging portion 136, the first sidewall 140 and the second sidewall 142 are made of the composite material. In one example, the composite material is a carbon fiber reinforced polymer. In another example, the composite material is a fiber reinforced composite (e.g., a fiber reinforced nylon). In other examples, other composite materials may be used. The fiber reinforced nylon may be molded. The fiber may be a carbon fiber. In other examples, fibers such as aramid (e.g., Kevlar™), fiberglass, boron fibers, ceramic fibers, nylon, or other fibers may be used. The fiber may be a combination of fibers. The fibers may be of various lengths. A resin system of the fiber reinforced composite may be, for example, an epoxy. The resin may be fortified with particulate, nanotubes, fibers, and nanostructures. In one example, the fiber reinforced composite may be a thermoset. In another example, the fiber reinforced composite may be a thermoplastic. The fiber reinforced composite may include bismaleimide, polyphenylene sulfide, polyetherimide, polyamide, polyetheretherketone, polystyrene, nylon, polypropylene, polyethylene, vinyls, acrylics, and/or polycarbonates. In another example, the rim 122 may include steel, titanium, aluminum, magnesium, or any other material forming part of the rim 122. Portions of the rim 122 may be hollow or solid, and composed of multiple layers of varying materials. The rim 122 may be any number of sizes and may have any diameter.

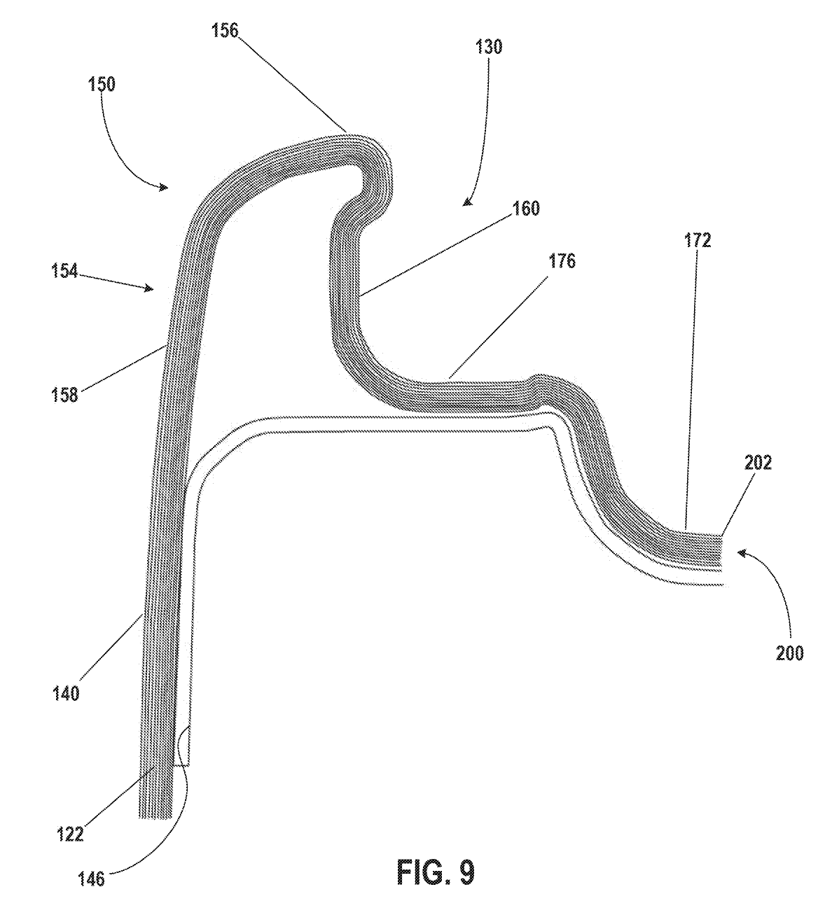

Referring to FIG. 9, at least a portion of the rim 122 is formed with a stack 200 of continuous plies or layers 202 (e.g., layers) of the composite material (e.g., the CFRP). Woven plies, unidirectional plies, or combinations thereof may be used. In an embodiment, each of the layers 202 of the composite material is unidirectional. In other words, fibers, or strands, within the respective layer 202 are oriented so as to have a primary strength orientation. For example, the fibers, or strands, may be oriented in a single or a same direction.

In one example, at least the tire engaging portion 130, the first sidewall 140, and the second sidewall 142 are formed with the stack 200 of the continuous layers 202 of the CFRP. More or less of the rim 122 may be formed with the stack 200 of continuous layers 202 of the CFRP. In one example, the layers 202 of the composite material extend and are continuous from at least the first sidewall 140, through the first tire retaining portion 150. In an embodiment the continuous layers 202 extend to the first shelf 176, and at least part of the well 172. The layers 202 of composite material may be continuous through the entire first protrusion 156. The layers 202 of the composite material may also extend through the remainder of the well 172, the second shelf 178, the second tire retaining portion 152, and at least a portion of the second sidewall 142. The layers 202 of composite material are thus continuous through the entire second protrusion 164. In other words, the layers 202 of the composite material extend through the entire radially outer tire engaging portion 130 (e.g., the first tire retaining portion 150 and the second tire retaining portion 152) and through at least portions of the first sidewall 140 and the second sidewall 142, respectively.

A number of benefits result from the use of the continuous layers 202 of the composite material to form, for example, the radially outer tire engaging portion 130. The rim 122 may be designed with these benefits in mind. For example, the fibers of the stack 200 of continuous layers 202 of the composite material perform well in tension, particularly along a primary strength orientation. For example, to take advantage of this property, the first sidewall 140 and the first outer wall 158 and the first tire retaining wall 160 of the first tire retaining section 154, and the second sidewall 142 and the second outer wall 166 and the second tire retaining wall 168 of the second tire retaining section 162, respectively, may be straight to keep the fibers within the layers 202 of the composite material straight (e.g., in line with directions in which the first sidewall 140, the first outer wall 158, the first tire retaining wall 160, the second sidewall 142, the second outer wall 166, and the second tire retaining wall 168 extend, respective) and in tension. As another example, the use of the continuous layers 202 of the composite material through the first protrusion 156 and the second protrusion 164 provides a stronger rim compared to the prior art, as the layers 202 of the composite material are not cut and stacked to form the width of the tire retaining portions or the first protrusion 156 (e.g., including the first hook 161) or the second protrusion 164 (e.g., including the second hook 169), as done in the prior art. This reduces the number of exposed, or otherwise unconstrained, layer ends, which also eliminates the crack initiation at ply interfaces that may occur around a fiber retention portion of the first hook and the second hook of the prior art.

In an embodiment, a rim for a bicycle wheel is provided. The rim includes a radially outer tire engaging portion having a first tire retaining portion and a second tire retaining portion spaced apart from the first tire retaining portion. The rim also includes a first sidewall, the first tire retaining portion extending from the first sidewall. The rim also includes a second sidewall spaced apart from the first sidewall, the second tire retaining portion extending from the second sidewall, the first sidewall and the second sidewall extending radially inward of the radially outer tire engaging portion. In an embodiment, the first tire retaining portion includes a first tire retaining section, the first tire retaining section including a first set of layers of a first composite material forming a first outer wall and a second set of layers of a second composite material forming a first tire retaining wall opposite the first outer wall. In an embodiment, such as that illustrated with respect to FIG. 9, the first composite material and the second composite material may be a same composite material. For example, the composite material may be a carbon fiber based composite material.

In an embodiment, the first set of layers is spaced apart from the second set of layers by a substance having a lower density than the composite material. The substance may be any material having a lower density than the composite material, such as air or a foam material.

In an embodiment, the second tire retaining portion includes a second tire retaining section, the second tire retaining section including a third set of layers of composite material forming a second outer wall and a fourth set of layers of composite material forming a second tire retaining wall opposite and spaced apart from the second outer wall, and wherein the third set of layers is spaced apart from the fourth set of layers by the substance having a lower density than the composite material.

In an embodiment, the radially outer tire engaging portion, the first sidewall, and the second sidewall are formed of a same composite material, for example layers of the same composite material.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations and/or acts are depicted in the drawings and described herein in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that any described program components and systems can generally be integrated together in a single software product or packaged into multiple software products.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, are apparent to those of skill in the art upon reviewing the description.

The Abstract of the Disclosure is provided to comply with 37 C.F.R. § 1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is intended that the foregoing detailed description be regarded as illustrative rather than limiting and that it is understood that the following claims including all equivalents are intended to define the scope of the invention. The claims should not be read as limited to the described order or elements unless stated to that effect. Therefore, all embodiments that come within the scope and spirit of the following claims and equivalents thereto are claimed as the invention.

What is claimed is:

1. A rim for a bicycle wheel, the rim comprising:
a radially outer tire engaging portion having a first tire retaining portion and a second tire retaining portion spaced apart from the first tire retaining portion;
a first sidewall, the first tire retaining portion extending from the first sidewall; and
a second sidewall spaced apart from the first sidewall, the second tire retaining portion extending from the second sidewall, the first sidewall and the second sidewall extending radially inward of the radially outer tire engaging portion,
wherein the first tire retaining portion includes a first tire retaining section, the first tire retaining section including a first set of layers of composite material forming a first outer wall and a second set of layers of composite material forming a first tire retaining wall opposite the first outer wall, and wherein the first set of layers is spaced apart from the second set of layers by a substance having a lower density than the composite material.

2. The rim of claim 1, wherein the second tire retaining portion includes a second tire retaining section, the second tire retaining section including a third set of layers of composite material forming a second outer wall and a fourth set of layers of composite material forming a second tire retaining wall opposite and spaced apart from the second outer wall, and wherein the third set of layers is spaced apart from the fourth set of layers by the substance having a lower density than the composite material.

3. The rim of claim 1, wherein the radially outer tire engaging portion, the first sidewall, and the second sidewall are formed of a same composite material.

4. The rim of claim 2, wherein the first tire retaining portion further includes a first hook, the first hook extending between the first outer wall and the first tire retaining wall, and
wherein the second tire retaining portion further includes a second hook, the second hook extending between the second outer wall and the second tire retaining wall.

5. The rim of claim 1, wherein the first outer wall and the first tire retaining wall are separated by four to ten millimeters, and the second outer wall and the second tire retaining wall are separated by four to ten millimeters.

6. The rim of claim 1, wherein the substance having a lower density than the composite material is air.

7. The rim of claim 1, wherein the substance having a lower density than the composite material is a foam.

8. The rim of claim 1, wherein the first outer wall and the first tire retaining wall include layers of the composite material, the first set of layers of the composite material forming the first tire retaining wall and the second set of layers forming the first outer wall are continuous layers from the first outer wall to the first tire retaining wall.

9. A rim for a bicycle wheel, the rim being made of a composite material and comprising:
a radially outer tire engaging portion having a first tire retaining portion and a second tire retaining portion spaced apart from the first tire retaining portion;
a first sidewall, the first tire retaining portion extending from the first sidewall; and a second sidewall spaced apart from the first sidewall, the second tire retaining portion extending from the second sidewall, the first sidewall and the second sidewall extending radially inward of the radially outer tire engaging portion,
wherein the first tire retaining portion includes a first tire retaining section, the first tire retaining section including a first outer wall and a first tire retaining wall opposite and spaced apart from the first outer wall,
wherein the second tire retaining portion includes a second tire retaining section, the second tire retaining section including a second outer wall and a second tire retaining wall opposite and spaced apart from the second outer wall, and
wherein the first outer wall, the first tire retaining wall, the second tire retaining wall, and the second outer wall include layers of the composite material, the layers of the composite material being continuous from the first outer wall to the second outer wall, through the first tire retaining wall and the second tire retaining wall.

10. The rim of claim 9, wherein fibers of the composite material are carbon fibers.

11. The rim of claim 9, wherein the continuous layers of the first tire retaining portion form a first protrusion from the first tire retaining wall, towards the second tire retaining portion,
wherein the continuous layers of the second tire retaining portion form a second protrusion from the second tire retaining wall, towards the first tire retaining portion, and
wherein the layers of the composite material are continuous around and through the first protrusion and the second protrusion.

12. The rim of claim 9, wherein the first outer wall and the first tire retaining wall are separated by four to ten millimeters, and the second outer wall and the second tire retaining wall are separated by four to ten millimeters.

13. The rim of claim 9, wherein the first outer wall and the first tire retaining wall, and the second outer wall and the second tire retaining wall, respectively, are separated by air.

14. The rim of claim 9, wherein the first outer wall and the first tire retaining wall, and the second outer wall and the second tire retaining wall, respectively, are separated by a foam.

15. The rim of claim 9, wherein the radially outer tire engaging portion, the first sidewall, and the second sidewall are made of the same composite material.

16. A wheel for a bicycle, the wheel comprising:
a central hub configured for rotational attachment to the bicycle;
a plurality of spokes attached to the central hub and extending radially outward from the hub, the plurality of spokes consisting of a number of spokes; and
a rim comprising:
a radially outer tire engaging portion having a first tire retaining portion and a second tire retaining portion spaced apart from the first tire retaining portion;
a first sidewall, the first tire retaining portion extending from the first sidewall;
a second sidewall spaced apart from the first sidewall, the second tire retaining portion extending from the second sidewall, the first sidewall and the second sidewall extending radially inward of the radially outer tire engaging portion; and
a radially inner portion disposed along an inner circumference of the rim, the plurality of spokes being attached to the radially inner portion of the rim,
wherein the radially outer tire engaging portion includes layers of the composite material, the layers of the composite material being continuous from the first tire retaining portion to the second tire retaining portion, such that the layers of the composite material are continuous around and through the radially outer tire engaging portion.

17. The wheel of claim 16, wherein the first tire retaining portion includes a first tire retaining section, the first tire retaining section including a first outer wall and a first tire retaining wall opposite and spaced apart from the first outer wall, and
wherein the second tire retaining portion includes a second tire retaining section, the second tire retaining section including a second outer wall and a second tire retaining wall opposite and spaced apart from the second outer wall.

18. The wheel of claim 17, wherein the first outer wall and the first tire retaining wall, and the second outer wall and the second tire retaining wall, respectively, are separated by a material having a lower density than the composite material.

19. The wheel of claim 18, wherein the lower density material is a foam.

20. The wheel of claim 17, wherein the first outer wall and the first tire retaining wall, and the second outer wall and the second tire retaining wall, respectively, are separated by only air.
